(19) United States
(12) Patent Application Publication
(10) Pub. No.: US 2025/0381943 A1
(43) Pub. Date: Dec. 18, 2025

(54) PRESSURE PLATE, BRAKE ACTUATOR, AND BRAKING ASSEMBLY FOR A VEHICLE

(71) Applicant: ZF CV Systems Europe BV, Brussels (BE)

(72) Inventors: P. Pratheesh Prem Kumar, Coimbatore (IN); Senthil Kumar Arangarasan, Chennai (IN)

(21) Appl. No.: 19/235,833

(22) Filed: Jun. 12, 2025

(30) Foreign Application Priority Data
Jun. 15, 2024 (IN) 202411046349

(51) Int. Cl. B60T 17/00; B60T 13/38; B60T 17/08

(52) U.S. Cl. CPC B60T 17/00; B60T 13/38; B60T 17/083

(57) ABSTRACT

A pressure plate (100) for a brake actuator has a base section (102) and a peripheral radial wall (104) extending from the base section in a longitudinal direction (L). A peripheral rim (106) is arranged on a distal end (108) of the peripheral radial wall for connecting to a non-pressure plate of the brake actuator. An inlet port (110) is provided for receiving a pressurized fluid (CA). A central opening (112) is arranged on the base section and is configured to receive a pressure rod of a spring brake unit. A connection element (114) is configured to cooperate with both a respective cooperating connection element of a cover, configured to tightly close the central opening, and also with a respective cooperating connection element of a spring brake unit, such that the pressure rod of the spring brake unit is aligned with the central opening.

### FIELD

The present disclosure is directed to a pressure plate for a brake actuator that enables a modular approach for service brake actuators and parking brake actuators. The present disclosure is further directed to a pressure plate arrangement for a service brake actuator, to a service brake actuator including a pressure plate arrangement, to a parking brake actuator including a pressure plate, to a braking arrangement and to a vehicle.

### BACKGROUND

In known service brake actuators, the housing includes a pressure plate and a non-pressure plate, typically connected by way of a clamp ring and with an elastic diaphragm arranged therebetween and dividing an inner volume of the service brake actuator in a first chamber, where actuating pressurized fluid is received, and a second chamber that houses a push rod for applying a braking force when the pressurized fluid is received. The pressure plate and the diaphragm enclose the first chamber that gets pressurized when the fluid is received, hence the name.

In known parking brake actuators, i.e., brake actuators having a combined service brake functionality and a parking brake functionality, the pressure plate found in the service brake actuators is typically replaced by a flange to which a parking brake unit or spring brake unit is attached. The flange has an opening for a pressure rod, which allows a mechanical actuation of the diaphragm and of the push rod via a pressure rod that moves through the opening in the flange, when a parking brake signal is received. Also, the flange and the parking brake unit, together with the diaphragm, enclose the first chamber, which is pressurized during operation of the service brake actuator.

### SUMMARY

It would be therefore beneficial to enable to improve the integration of the different brake actuators to fulfill varying customer and engineering requirements.

This is where the present disclosure comes in, wherein it is an objective of the present disclosure to provide a solution to the above mentioned problem.

According to a first aspect of the present disclosure a pressure plate for a brake actuator is disclosed. The pressure plate includes a base section extending in a base plane perpendicular to a longitudinal, or axial, direction of the pressure plate. The pressure plate also includes a peripheral radial wall extending from the base section in the longitudinal or axial direction, thereby forming a skirt around the base section. A peripheral rim is arranged on a distal end of the peripheral radial wall for connecting to a non-pressure plate for forming a housing of the brake actuator. The non-pressure plate is not a feature of the pressure plate of the first aspect of the present disclosure. The pressure plate also includes an inlet port for receiving a pressurized fluid and a central opening arranged on the base section and configured to receive a pressure rod of a spring brake unit. The spring brake unit is also not a feature of the pressure plate of the first aspect of the present disclosure.

The pressure plate of the first aspect includes a connection element that is arranged enclosing the central opening and that is configured to selectively cooperate, in particular non-simultaneously, with a respective cooperating connection element of a cover configured to tightly close the central opening, for operation of the brake actuator in a service brake mode, and also with a respective cooperating connection element of a parking brake chamber, such that the pressure rod of the spring brake unit is aligned with the central opening, for operation of the brake actuator in a parking brake mode.

Thus, the inventive pressure plate can be advantageously used for both service brake actuators and parking brake actuators, allowing for a modular design of the brake actuators.

In the following, developments of the pressure plate of the first aspect of the present disclosure will be disclosed.

A preferred, but not limiting, non-simultaneous cooperation with the cover and the spring brake unit indicates that the connection element is configured to cooperate with both the cover and the spring brake unit but, at any given point in time, only one of them (or none) can be connected, or, in other words, the cover and the spring brake unit cannot be connected simultaneously to the pressure plate.

In a development, the inlet port is arranged on the peripheral radial wall.

In another development, the connection element is arranged on an exterior side of the base section. The exterior side refers to a service side, which, in operation of a service brake actuator, is accessible by a user, in opposition to the interior side. Accessing the interior side typically requires dismantling the brake actuator and separating the pressure plate from the non-pressure plate.

In yet another development, the connection element of the pressure plate is configured as a threaded connector. The threaded connector includes a thread, which can be an outer thread or an inner thread, which is for instance arranged on a protruding section. In an alternative development, the connection element of the pressure plate is configured as a push-lock connector or as a ball locking mounting system.

A push lock connector, also referred to as push lock fitting, can be used in low-pressure hydraulic and pneumatic systems and has the advantage that no clamps or crimp sleeves are necessary to secure the fitting.

A second aspect of the present disclosure is formed by a pressure plate arrangement suitable for use in a service brake actuator. The pressure plate arrangement includes a pressure plate in accordance with the first aspect of the present disclosure and a cover including a cooperating connection element configured to tightly close the central opening of the pressure plate. The cover is used as a protective cap for closing the central opening and preventing air leakage during operation of a service brake actuator that includes the pressure plate arrangement of the present disclosure. Thus the pressure plate arrangement offers the same functionality as the known pressure plates for service brakes actuators.

The pressure plate arrangement thus shares the advantages of the pressure plate of the first aspect of the present disclosure.

In a development of the pressure plate arrangement, the pressure plate and the cover include cooperating connection elements that form a threaded connection, or a push-lock connection or a ball locking mounting system.

A third aspect of the present disclosure is formed by a service brake actuator. The service brake actuator in accordance with the present disclosures includes a pressure plate arrangement in accordance with the second aspect and a non-pressure plate. The non-pressure plate is connected to the peripheral rim of the pressure plate, and includes a push-rod opening. The service brake actuator of the third aspect also includes a diaphragm arranged between the pressure plate and the non-pressure plate and configured to divide an inner volume of the service brake actuator in a first chamber connected to the inlet port and a second chamber connected to, i.e., in fluid communication with, the push rod opening. A push rod is connected to the diaphragm and arranged in the second chamber such that a distal end of the push rod protrudes out of the non-pressure plate via the push-rod opening. In the service brake actuator of the third aspect of the present disclosure, the cover is arranged to tightly close the central opening of the pressure plate for forming the first chamber. Further, the pressure plate, the non-pressure plate, and the cover form a housing of the service brake actuator.

According to a fourth aspect of the present disclosure, a parking brake actuator is disclosed. The parking brake actuator is a brake actuator that has a service brake functionality and a parking brake functionality. The parking brake actuator includes a pressure plate in accordance with the first aspect of the present disclosure. As in the case of the service brake actuator of the third aspect, the parking brake actuator also includes a non-pressure plate connected to the peripheral rim of the pressure plate, the non-pressure plate having a push-rod opening, a diaphragm arranged between the pressure plate and the non-pressure plate and configured to divide an inner volume of a service section of the parking brake actuator in a first chamber connected to the inlet port and a second chamber connected to the push rod opening and a push rod connected to the diaphragm and arranged in the second chamber such that a distal end of the push rod protrudes out of the non-pressure plate via the push-rod opening.

In addition, the parking brake actuator of the fourth aspect includes a spring brake unit that includes a cooperating connection element configured to cooperate with the connection element of the pressure plate. The spring brake unit also includes a pressure rod configured to actuate the push rod via the central opening of the pressure plate upon reception of a parking brake signal.

In a development, the pressure plate and the spring brake unit include cooperating connection elements that form a threaded connection, or a push-lock connection, or a ball locking mounting system.

A fifth aspect of the present disclosure is formed by a braking assembly that includes a compressor unit configured to generate and provide compressed air, it optionally includes an air drying unit connected to the compressor unit and configured to dry the compressed air and provide dried compressed air, a compressed air reservoir connected to the compressor, in particular via the optional air drying unit and configured to store the dried compressed air, and one or more service brake actuators according to the third aspect and/or one or more parking brake actuators according to the forth aspect, both configured to exert a braking force via the push-rod in response to receiving dried compressed air from the compressed air reservoir, and, optionally, in the case of parking brake actuators, in response to receiving a parking brake signal.

A sixth aspect of the present disclosure is formed by a vehicle, in particular a commercial vehicle, including a service brake actuator in accordance with the third aspect, and/or a parking brake actuator in accordance with the fourth aspect and/or a braking assembly in accordance with the fifth aspect.

These and other aspects of the present disclosure will be apparent from and elucidated with reference to the embodiments described hereinafter.

The embodiments of the present disclosure are described in the following on the basis of the drawing in comparison with the state of the art, which is also partly illustrated. The latter is not necessarily intended to represent the embodiments to scale. The drawing is, where useful for explanation, shown in schematized and/or slightly distorted form. With regard to additions to the teaching immediately recognizable from the drawing, reference is made to the relevant prior art. It should be kept in mind that numerous modifications and changes can be made to the form and detail of an embodiment without deviating from the general concept of the present disclosure.

The features of the present disclosure disclosed in the description, in the drawing and in the claims may be essential for a further development of the present disclosure, either individually or in any combination. In addition, all combinations of at least two of the features disclosed in the description, drawing and/or claims fall within the scope of the present disclosure.

The general concept of the present disclosure is not limited to the exact form or detail of the preferred embodiments shown and described below or to a subject matter, which would be limited in comparison to the subject matter as claimed in the claims.

For specified design ranges, values within specified limits of the ranges are also disclosed as limit values and thus are arbitrarily applicable and claimable.

### BRIEF DESCRIPTION OF THE DRAWINGS

The various aspects of the present disclosure are described further below and in reference to the drawings, in which:

FIG. 1A is a perspective view of an exemplary pressure plate in accordance with an embodiment of the present disclosure

FIG. 1B is a side view of the exemplary pressure plate of FIG. 1A;

FIG. 2 is a cross-sectional view of an exemplary pressure plate in accordance with another embodiment of the present disclosure;

FIG. 3 is a cross-sectional view of an exemplary service brake actuator including a pressure plate arrangement in accordance with another embodiment of the present disclosure;

FIG. 4 is a cross-sectional view of a spring brake unit for use with a pressure plate in accordance with another embodiment of the present disclosure;

FIG. 5 is a cross-sectional view of a flange of a spring brake unit connected to a pressure plate in accordance with another embodiment of the present disclosure;

FIG. 6 is a cross-sectional view of a parking brake actuator including a pressure plate in accordance with another embodiment of the present disclosure, arranged between a spring brake unit and a service brake unit.

FIG. 7 is a schematic block diagram of a vehicle including a braking assembly in accordance with another embodiment of the present disclosure.

### DETAILED DESCRIPTION

For the following discussion of the figures, and for the sake of simplicity, those technical features having a similar or identical function will be referred to using the same reference numbers or reference signs.

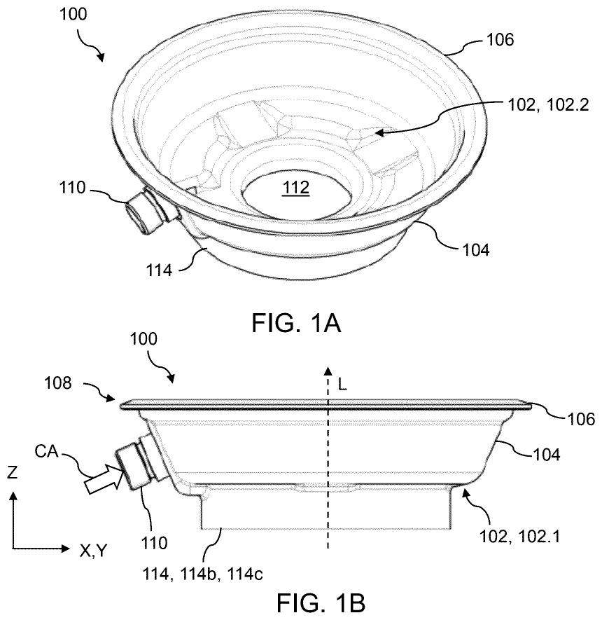

FIG. 1A illustrates a perspective view of an exemplary pressure plate 100 in accordance with an embodiment of the present disclosure.

FIG. 1B illustrates a side view of the exemplary pressure plate 100 of FIG. 1A.

Regarding FIGS. A1 and 1B, the pressure plate 100 is suitable for use in a service brake actuator or a parking brake actuator, as it will be explained below. The pressure plate 100 includes a base section 102 extending in a base plane XY perpendicular to a longitudinal direction L of the pressure plate, which, in FIG. 1B, corresponds to an axial direction Z. FIG. 1A shows an interior side 102.2 of the base section 102 and FIG. 1B shows an exterior side 102.1 of the base section 102. The pressure plate 100 also includes a peripheral radial wall 104 extending from the base section 102 in the longitudinal direction L. A peripheral rim 106 is arranged on a distal end 108 of the peripheral radial wall 104 for connecting to a non-pressure plate for forming a housing of the brake actuator, as it will be explained below. In the particular exemplary pressure plate 100 of FIGS. 1A and 1B, the peripheral radial wall 104 extends in the longitudinal direction L with an increasing radius from the base plate towards the distal end 108. In other examples, the peripheral radial wall can be parallel, at least in one or more sections, to the longitudinal direction L.

The pressure plate 100 also includes an inlet port 110 that is arranged and configured to receive a pressurized fluid, such as, for instance, compressed air CA provided, for example, by a compressor. The inlet port enables a fluid connection between an interior portion of the pressure plate 100 and an exterior portion of the pressure plate. In this particular non-limiting example, the inlet port 110 is arranged on the peripheral radial wall 104. Alternatively, the inlet port can be arranged on the base plate 102, preferably in a non-central position.

The pressure plate 100 also includes a central opening 112 (see FIG. 1A) that is arranged on the base section 102 and configured to receive a pressure rod of a spring brake unit, as it will be explained below. Thus, the central opening, which is located at a central location of the base plate, is dimensioned to allow the pressure rod to move through the central opening 112.

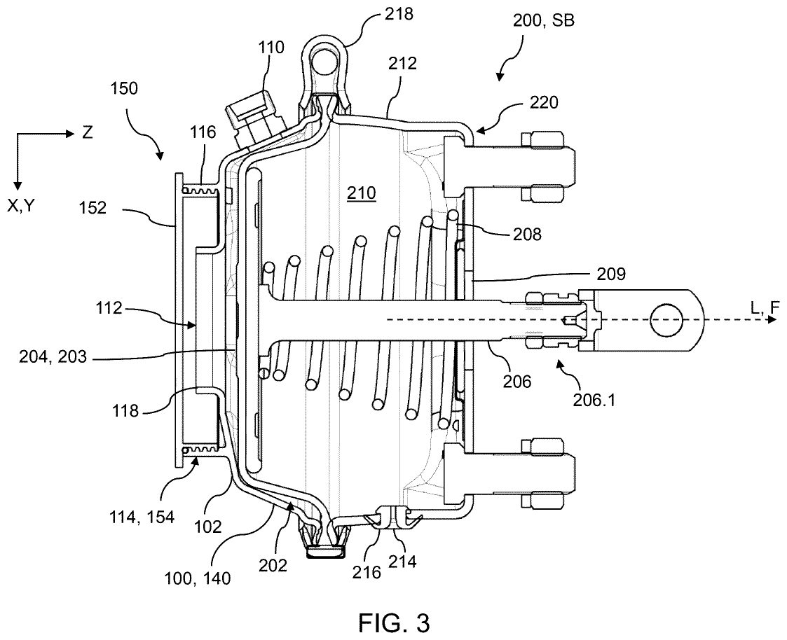

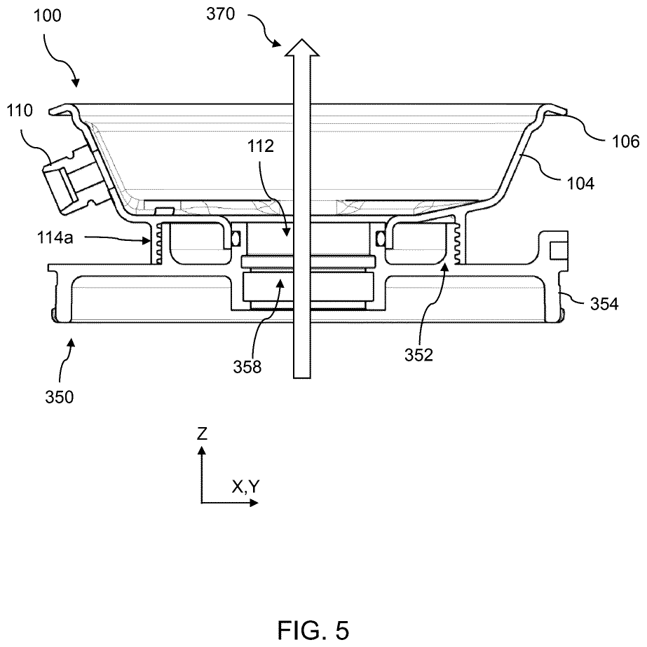

Further, a connection element 114 is provided. The connection element 114 is arranged such that it radially encloses or surrounds the central opening 112. The connection element 114 is configured to cooperate, in particular with one of the following at a given time, with a respective cooperating connection element of a cover configured to tightly close the central opening 112, for operation of the brake actuator in a service brake mode, and with a respective cooperating connection element of a spring brake unit, such that the pressure rod of the spring brake unit is aligned with the central opening 112, for operation of the brake actuator in a parking brake mode. This will be further explained below with reference to FIG. 3 for the service brake actuator and the service brake mode and to FIG. 5 for the parking brake actuator and the corresponding parking brake mode. Thus, the connection element in designed or configured to interact with a cooperating connection element, which can be part of a cover (see e.g., FIG. 3) or of a spring brake unit (see e.g., FIG. 5).

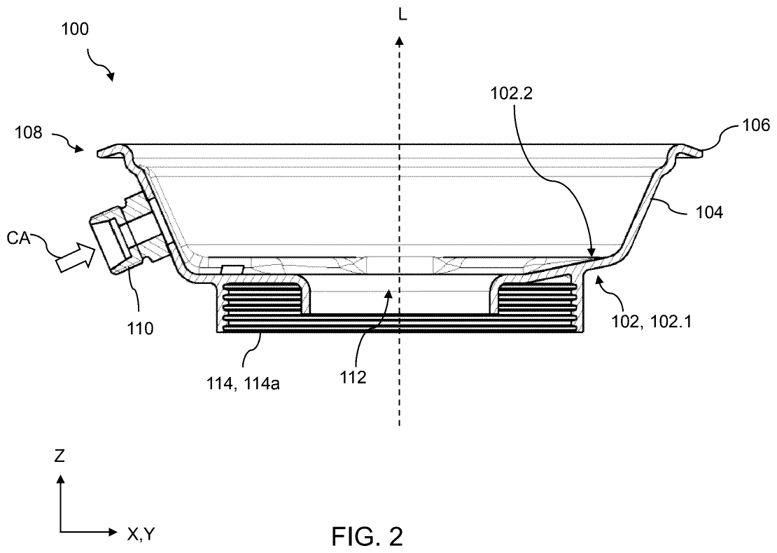

The connection element 114 of the pressure plate 100 can be for example configured as a threaded connection element (see e.g., FIG. 2), as a push-lock connector 114b, or as a ball locking mounting system 114c.

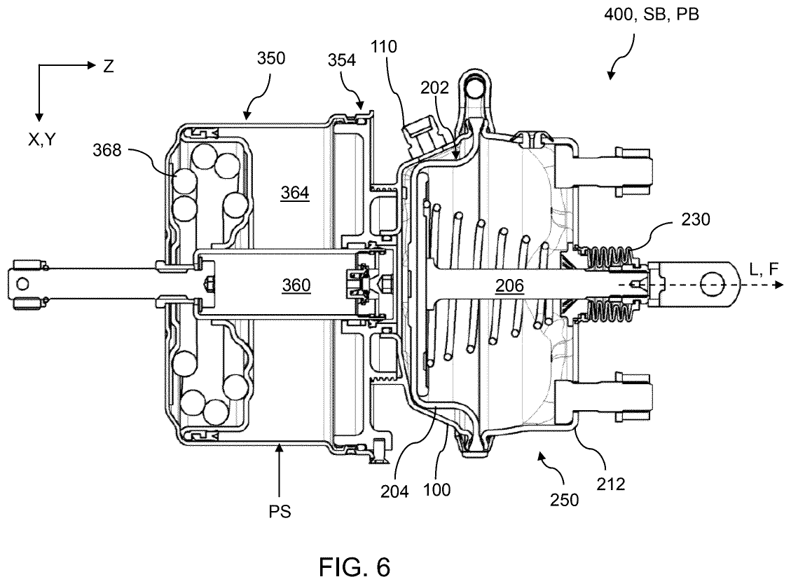

FIG. 2 shows a cross-sectional view of an exemplary pressure plate 100 in accordance with another embodiment of the present disclosure. The pressure plate 100 of FIG. 2 presents a connection element 114 in the form of a threaded connection element 114a to which a cover (see e.g., FIG. 3) or a spring brake unit (see e.g., FIG. 6) can be connected. The provision of a pressure brake to which several different cooperating elements can be connected enables a modular design of the brake actuators. The modular design refers to a product design by organizing sub-assemblies and components as distinct building blocks or modules that can be integrated through appropriate configuration to fulfill various customer and/or engineering requirements.

FIG. 3 shows a cross-sectional view of an exemplary service brake actuator 200 including a pressure plate arrangement 150 in accordance with another embodiment of the present disclosure. The pressure plate arrangement 150 includes the pressure plate 100 (see for instance the discussion regarding FIGS. 1A, 1B and 2 above) and a cover 152. The cover 152 includes a cooperating connection element 154 that is configured to cooperate with the connection element 114 of the pressure plate 100 to tightly close the central opening 112 of the pressure plate 100. Thus, the opening 112 cannot be accessed from the exterior of the service brake actuator because it is covered by the cover. Here, the connection element 114 of the pressure plate is arranged on an interior wall of a protruding radial element 116 having a larger radius than a minimum radius of the opening 112, which in FIG. 3 is delimited by a radial opening lip 118, enclosed by the protruding radial element 116 where the connection element 114 is arranged. During operation of the service brake actuator 200, i.e., when the service braking actuator 200 is actuated, for example, when a driver actuates the brake pedal, compressed air CA from a brake valve flows through inlet port 110 and into a first chamber 202 that is delimited by the pressure plate arrangement 150 on a proximal side, and by a movable separation element 203, which in this particular case is an elastic diaphragm 204, on a distal side. The movable separation element 203 can alternatively be a rigid element configured to slide along the inner wall of the housing of the brake actuator. The pressure building up in the first chamber 202 acts on the diaphragm 204 and pushes it, together with a push rod 206 attached to the diaphragm 204 along the longitudinal direction L, against the force a pressure spring 208 arranged inside a second chamber 210. The second chamber is delimited by a non-pressure plate 212 and by the movable separation element, in this example, the elastic diaphragm 204. The non-pressure plate 212 includes a push rod opening 209, through which a distal end 206.1 of the push rod 206 can move in the longitudinal direction L to exert a braking force F. When the braking process is ended, the pressure in the first chamber 202 is reduced by an upstream brake valve. At the same time, the pressure spring 208 returns both the push rod 206 and the diaphragm 204 to their original positions. The first chamber 202 is tight due to the tight connection between the connection element 114 of the pressure plate 100 and the cooperating connection element 154 of the cover, and because of a tight connection between the pressure plate 100 and the non-pressure plate 212. In particular, FIG. 3 also shows a fastening arrangement 218 for fastening the diaphragm 204 between the pressure plate 100, in particular the peripheral rim (106, see FIG. 1A, 1B or 2), and the non-pressure plate 212 by way of, for instance, a fastening clip 218, preferably a circumferential fastening clip.

Optionally, a filter 214 fitted in front of the air outlet holes 216 of the non-pressure plate 212 prevents dirt or dust penetrating into the second chamber 210 when the push rod 206 returns to its original position.

The housing 220 of the service brake actuator 200 is therefore formed by the pressure plate arrangement 150, which includes the pressure plate 100 and the cover 152 and by the non-pressure plate 212.

The use of the pressure plate 100 in accordance with the present disclosure enables a modular design of the service brake actuator 200 also as a parking brake actuator by removing the cover 152 and connecting a spring brake unit to the connection element 114.

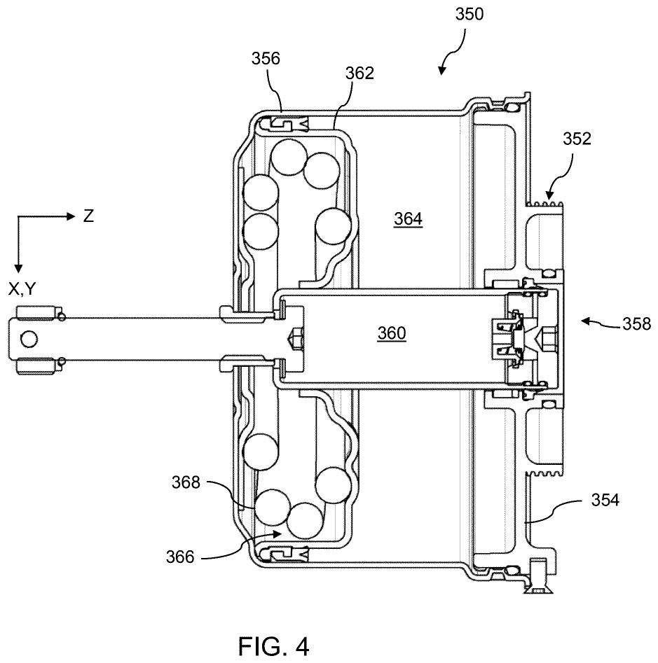

This is shown in FIG. 4, which illustrates a cross-sectional view of a spring brake unit 350 for use with a pressure plate 100 in accordance with another embodiment of the present disclosure. The spring brake unit 350 includes a cooperating connection element 352, for instance a threaded connection element 352 for cooperating with the threaded connection element 114a of the pressure plate 100. The threaded connection element 152 is arranged on a flange 354, which forms part of a housing 356 of the spring brake unit 350. The flange 354 includes a flange opening 358 through which a pressure rod 360 can protrude. A movable separation element 362 of the spring brake unit 350 divides an inner volume of the housing 356 into a first parking brake chamber 364 and a second parking brake chamber 366, which houses a spring element or compression spring 368. The operation of the spring brake unit is known to the person skilled in the art and will be briefly discussed with reference to FIG. 6 below.

FIG. 5 illustrates in more detail, in a cross-sectional view, a threaded connection between a threaded connection element 352 arranged on the flange 354 of a spring brake unit 350 and a cooperating threaded connection element 114a arranged on the pressure plate 100 in accordance with another embodiment of the present disclosure. With the treaded connection, the flange opening 358 of the flange 354 is aligned with the central opening 112 of the pressure plate providing a global opening 370, such that, when the parking brake actuator is in operation, the pressure rod 360 (see FIG. 4) can protrude through the global opening 370 to actuate the movable separation element 203 of the service brake actuator, e.g., the elastic diaphragm 204.

FIG. 6 illustrates a cross-sectional view of a parking brake actuator 400 including a pressure plate 100 in accordance with another embodiment of the present disclosure, arranged between a spring brake unit 350 and a service brake unit 250. The operation of the parking brake actuator 400 in the service brake mode SB is identical to that described with reference to FIG. 3. The tight connection between the flange 354 and the pressure plate 100 together with the tight arrangement of the pressure rod 360 in the spring brake unit 350, and the tight connection between the pressure plate 100 and the non-pressure plate 212, creates a fluid tight first chamber 202 in the service brake unit 250 that can be pressurized with fluid, such as compressed air CA, provided via the inlet port 110 to drive the diaphragm 204 and the push rod 206 out of the service brake unit 250 for exerting the braking force F in the longitudinal direction. In addition to the service brake unit 250 of FIG. 3, the service brake unit 250 of FIG. 6 further includes a bellow connected to the distal end 206.1 of the push rod 206 and configured to protect the push rod opening 209.

During operation of the parking brake actuator 400 in the parking brake mode PB, when the parking brake is actuated the pressure in the first parking brake chamber 364 is fully or partially released via a release port, which is preferably located on the peripheral radial wall of the flange 354 or on the housing 356. In this process, the force of the relaxing compression spring 368 acts on the movable separation element 362 of the spring brake unit 350 (e.g. a wheel brake via piston) and on the pressure rod 360, which moves in the longitudinal direction and mechanically actuates the diaphragm 204 in the service park unit 250, thereby generating again a braking force F in the longitudinal direction L. The maximum braking force F of the spring brake unit 350 (i.e., the spring-loaded portion of the parking brake actuator 400) is achieved when the first parking brake chamber 364 is pressureless. Because this braking force F is achieved exclusively in a mechanical fashion, i.e., by compression spring 368, the spring-loaded portion may be used for the parking brake. When the brake is released, the pressure is once again increased in the first parking brake chamber 364, for instance via the release port, which is preferably located on the peripheral radial wall of the flange 354 or on the housing 356 and the compression spring 368 and the pressure rod 360 are brought back to their initial, unactuated, position shown in FIG. 6.

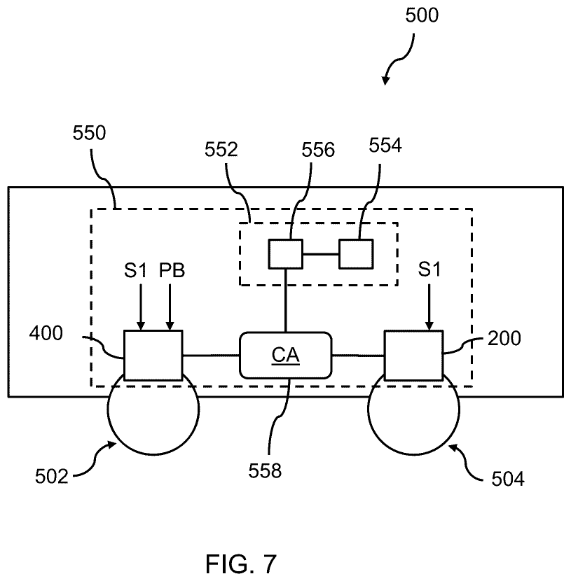

FIG. 7 shows a schematic block diagram of a vehicle 500, in particular a commercial vehicle such as a truck or a bus, including a braking assembly 550 in accordance with another embodiment of the present disclosure. The vehicle 500 includes, for example, a drive axle 502 and a steer axle 504. The braking assembly 550 includes an air processing unit 552 that includes a compressor 554 and an air drying unit 556, which is configured to absorb the moisture from the compressed air CA provided by the compressor 554. Additionally, the air drying unit may include filters such as oil filters. The compressed air CA provided by the compressor 554 and dried by the air drying unit 556 is then stored in a compressed air reservoir 558. Upon request, by providing a service brake signal S1, the stored compressed air CA is used to drive the service units 250 of the service brake actuator 200 arranged on the steer axle 504 and of the park brake actuator 400 arranged on the drive axle 502. The stored compressed air CA can also be used to operate other pneumatic systems of the vehicle 500, such as an air suspension system including air bellows (not shown). The compressed air CA stored in the reservoir 558 can also be used in a so-called regeneration phase of the air drying unit 556, for reducing the amount of moisture in the desiccant material.

The service brake actuator 200 and the parking brake actuators are configured to provide the braking force F, via the push rod piston 206, in response to the reception of the service brake signal S1, e.g., the driver actuating the brake pedal.

The parking brake actuator 400 is configured to provide the braking force F in response to the reception of one of two different braking signals. One is the service brake signal S1 (e.g. the driver actuating the brake pedal), and the other one is a parking brake signal PB (e.g. the driver actuating a hand-brake lever, or a parking brake button).

In summary, the present disclosure is directed to a pressure plate for a brake actuator, which includes a base section a peripheral radial wall extending from the base section in a longitudinal direction. A peripheral rim is arranged on a distal end of the peripheral radial wall for connecting to a non-pressure plate of the actuator. An inlet port is provided for receiving a pressurized fluid. A central opening is arranged on the base section and is configured to receive a pressure rod of a spring brake unit. A connection element configured to cooperate with a respective cooperating connection element of a cover configured to tightly close the central opening, and also with a respective cooperating connection element of a spring brake unit, such that the pressure rod of the spring brake unit is aligned with the central opening.

Other variations to the disclosed embodiments can be understood and effected by those skilled in the art in practicing the claimed present disclosure, from a study of the drawings, the disclosure, and the appended claims.

In the claims, the word “comprising” does not exclude other elements or steps, and the indefinite article “a” or “an” does not exclude a plurality. A single unit or device may fulfill the functions of several items recited in the claims. The mere fact that certain measures are recited in mutually different dependent claims does not indicate that a combination of these measures cannot be used to advantage. Any reference signs in the claims should not be construed as limiting the scope.

### LIST OF REFERENCE SIGNS (PART OF THE DESCRIPTION)

100 Pressure plate
102 Base section
102.1 Exterior side of base section
102.2 Interior side of base section
104 Peripheral radial wall
106 Peripheral rim
108 Distal end of peripheral radial wall
110 Inlet port
112 Central opening
114 Connection element
114a Connection element; threaded connection element
114b Connection element; push-lock connector
114c Connection element; ball locking mounting system
116 Protruding radial element
118 Radial opening lip
150 Pressure plate arrangement
152 Cover
154 Cooperating connection element
200 Service brake actuator
202 First chamber of service brake actuator
203 Movable separation element
204 Elastic diaphragm
206 Push rod
206.1 Distal end of push rod
208 Pressure spring
209 Push rod opening
210 Second chamber of service brake actuator
212 Non-pressure plate
214 Filter
216 Air outlet holes
218 Fastening arrangement
220 Housing
250 Service brake unit
350 Spring brake unit
352 Cooperating connection element of spring brake unit
354 Flange
356 Housing of spring brake unit
358 Flange opening
360 Pressure rod
362 Movable separation element of spring brake unit
364 First parking brake chamber
366 Second parking brake chamber
368 Spring element; compression spring
370 Global opening
400 Parking brake actuator
500 Vehicle
502 Drive axle
504 Steer axle
550 Braking assembly
552 Air processing unit
554 Compressor
556 Air drying unit
558 Compressed air reservoir
CA Compressed air
F Braking force
L Longitudinal direction
PB Parking brake mode
PS Parking brake signal
SB Service brake mode
XY Base plane
Z Axial direction

What is claimed is:

1. A pressure plate (100) for a brake actuator (200, 400), the pressure plate (100) comprising:
a base section (102) extending in a base plane (XY) perpendicular to a longitudinal direction (L) of the pressure plate (100) and a peripheral radial wall (104) extending from the base section (102) in the longitudinal direction (L);
a peripheral rim (106) arranged on a distal end (108) of the peripheral radial wall (104) configured to connect to a non-pressure plate (212) for forming a housing (220) of the brake actuator (200, 400);
an inlet port (110) configured to receive a pressurized fluid (CA);
a central opening (112) arranged on the base section (102) and configured to receive a pressure rod (360) of a spring brake unit (350);
a connection element (114) radially surrounding the central opening (112) and configured to cooperate with both a respective cooperating connection element (154) of a cover (152) and with a respective cooperating connection element (352) of a spring brake unit (350),
such that when the connection element cooperates with said cover, said cover is configured to tightly close the central opening (112), for operation of the brake actuator in a service brake mode (SB),
such that when the connection element cooperates with the spring brake unit, the pressure rod (360) of the spring brake unit (350) is aligned with the central opening (112), for operation of the brake actuator in a parking brake mode (PB).

2. The pressure plate (100) of claim 1, wherein the inlet port (110) is arranged on the peripheral radial wall (104).

3. The pressure plate (100) of claim 1, wherein the connection element (114) is arranged on an exterior side (102.1) of the base section (102).

4. The pressure plate (100) of claim 1, wherein the connection element (114) of the pressure plate (100) is configured as a threaded connector (114a).

5. The pressure plate (100) of claim 1, wherein the connection element (114) of the pressure plate is configured as a push-lock connector (114b) or as a ball locking mounting system (114c).

6. A pressure plate arrangement (150) for a service brake actuator (200), the pressure plate arrangement (150) comprising:
the pressure plate (100) in accordance with claim 1; and
a cover (152) comprising a cooperating connection element (154) that cooperates with the connection element (114) of the pressure plate (100) to tightly close the central opening (112) of the pressure plate (100).

7. The pressure plate arrangement (150) of claim 6, wherein the connection element (114) of the pressure plate (100) and the cooperating connection element (154) of the cover (152) form a threaded connection (114a), a push-lock connection (114b), or a ball locking mounting system (114c).

8. A service brake actuator (200), comprising:
the pressure plate arrangement (150) in accordance with claim 6;
a non-pressure plate (212) connected to the peripheral rim (106) of the pressure plate (100), the non-pressure plate having a push-rod opening (209);
a movable separation element (203) arranged between the pressure plate (100) and the non-pressure plate (212),
wherein the movable separation element (203) divides an inner volume (202, 210) of the service brake actuator (200) into a first chamber (202) connected to the inlet port (110) and a second chamber (210) connected to the push rod opening (209);
a push rod (206) connected to the movable separation element (203) and arranged in the second chamber (210) such that a distal end (206.1) of the push rod (206) protrudes out of the non-pressure plate (212) via the push-rod opening (209);
wherein the cover (152) tightly closes the central opening (212) of the pressure plate (100) to define the first chamber (202); and
wherein the pressure plate (100), the non-pressure plate (212), and the cover (152) form a housing of the service brake actuator (220).

9. A parking brake actuator (400), comprising:
the pressure plate (100) in accordance with claim 1;
a non-pressure plate (212) connected to the peripheral rim (106) of the pressure plate (100), the non-pressure plate (212) having a push-rod opening (209);
a movable separation element (203) arranged between the pressure plate (100) and the non-pressure plate (212),
wherein the movable separation element (203) divides an inner volume (202, 210) defined by the pressure plate and the non-pressure plate into a first chamber (202) connected to the inlet port (110) and a second chamber (210) connected to the push rod opening (209);
a push rod (206) connected to the movable separation element (203) and arranged in the second chamber (210) such that a distal end (206.1) of the push rod (206) protrudes out of the non-pressure plate (212) via the push-rod opening (209); and
a spring brake unit (350) comprising:
a cooperating connection element (352) that cooperates with the connection element (114) of the pressure plate (100), and
a pressure rod (360) that actuates the push rod (206) via the central opening (112) of the pressure plate (100) upon reception of a parking brake signal (PS).

10. The parking brake actuator (400) of claim 9, wherein the pressure plate (100) and the spring brake unit (350) comprise cooperating connection elements (114, 352) that form a threaded connection (114a), or a push-lock connection (114b), or a ball locking mounting system (114c).

11. A braking assembly (550) comprising:
a compressor unit (554) that generates and provides compressed air (CA);
a compressed air reservoir (558) connected to the compressor (554) and configured to store the dried compressed air (CA);
one or more parking brake actuators (400) according to claim 9,
wherein the parking brake actuator exerts a braking force (F) via the push rod (206) in response to receiving compressed air (CA) in the first chamber (202) from the compressed air reservoir (558).

12. The braking system of claim 11 further comprising an air drying (556) unit connected to the compressor unit (554) and configured to dry the compressed air (CA) and provide dried compressed air (CA), wherein the compressed air reservoir is connected to the compressor via the air drying unit (556).

13. The braking system of claim 12, wherein the parking brake actuator is further configured to exert a braking force via the push rod (206) in response actuation of the pressure rod in response to receiving a parking brake signal (PB).

14. A vehicle (500) comprising a braking assembly (550) in accordance with claim 11.

15. A braking assembly (550) comprising:
a compressor unit (554) that generates and provides compressed air (CA);
a compressed air reservoir (558) connected to the compressor (554) and configured to store the dried compressed air (CA);
one or more service brake actuators according to claim 8,
wherein the service brake actuator exerts a braking force (F) via the push rod (206) in response to receiving compressed air (CA) in the first chamber (202) from the compressed air reservoir (558).

16. A vehicle (500) comprising a braking assembly (550) in accordance with claim 15.

17. The service brake actuator (200) of claim 8, wherein the moveable separation element comprises a diaphragm (204).

18. The parking brake actuator of claim 9, wherein the moveable separation (203) element is an elastic diaphragm (204).

19. The pressure plate of claim 1, wherein only one of the cover and the spring brake unit is connectable to the connection element at a given time.

20. The pressure plate of claim 1,
wherein the central opening (112) is delimited by a radial opening lip (118);
wherein the connection element (114) is arranged on a protruding radial element (116) having a radius larger than a minimum radius of the central opening (112).
